(19) United States
(12) Patent Application Publication
(10) Pub. No.: US 2013/0254067 A1
(43) Pub. Date: Sep. 26, 2013

(54) System and Method for Networking Independent Sellers of Items

(71) Applicant: Zaheer Pirbhai, Lewisville, TX (US)

(72) Inventor: Zaheer Pirbhai, Lewisville, TX (US)

(21) Appl. No.: 13/425,420

(22) Filed: Mar. 21, 2012

(51) Int. Cl. G06Q 30/00

(52) U.S. Cl. 705/26.8

(57) ABSTRACT

A system and method for networking independent sellers of items is described herein. Specifically, a system that networks independent sellers of items can comprise a merchant-linking server memory that stores a plurality of affiliated partner profiles each associated with an affiliated partner, said affiliated partner profiles comprising a merchant address and an inventory catalog comprising a plurality of item listings, each identifiable by an item identifier, and a member profile associated with a member, said member profile comprising an item list, said item list comprising one or more of said item identifiers.

### BACKGROUND

This disclosure relates to a system and method for networking independent sellers of items.

Today, there are many furniture merchants across the country. Furniture merchants typically have physical showrooms, but are now often creating an online presence so that customers can view 8 tejs and even purchase from their homes. Online presence has allowed merchants to advertise to customers outside traditional local delivery areas. However, capturing remote customers has been a problem for two reasons: high shipping cost, and long delivery times. Customers expect delivery on the same day the order has been completed. Regarding high cost, the cost of furniture includes not only materials and labor to build the furniture, but also the cost to ship the furniture to the store, and later to ship the furniture to the customer's location. One solution to the high cost of shipping is to drop shipping from a manufacturer or a centralized warehouse to the furniture store but instead ship directly from a manufacturer or a centralized warehouse directly to the end customer. However, such solution does not satisfy the long delivery wait-time. Another solution is to have many warehouses in various locations in the country. However, such solution requires keeping a lot of inventory, which is impossible for most small furniture stores.

As such it would be useful to have an improved system and method for networking independent sellers of items.

### SUMMARY

A system and method for networking independent sellers of items is described herein.

In one embodiment, a system that networks independent sellers of items can comprise a merchant-linking server memory that stores a plurality of affiliated partner profiles each associated with an affiliated partner, said affiliated partner profiles comprising a merchant address and an inventory catalog comprising a plurality of item listings, each identifiable by an item identifier, and a member profile associated with a member, said member profile comprising an item list, said item list comprising one or more of said item identifiers. Moreover, the system that networks independent sellers of items can further comprise a server application, a merchant-linking server processor that, according to instructions from said server application, receives a requested item identifier and a customer address from one of said members, wherein said requested item identifier matches one of said item identifiers wherein said requested item identifier identifies a requested item said customer offers to purchase from said merchant, identifies each of said affiliated partner profiles that comprises said requested item identifies, determines distances between said customer address and said merchant address inside each of said affiliated partner profiles comprising said requested identifiers, and chooses one or more of said item listings based on said distances.

Additionally, a method for networking independent sellers of items is disclosed. The method can comprise storing in a memory a plurality of affiliated partner profiles each associated with an affiliated partner, said affiliated partner profiles comprising a merchant address and an inventory catalog comprising a plurality of item listings, each identifiable by an item identifier, storing in said memory a member profile associated with a member, said member profile comprising an item list, said item list comprising one or more of said item identifiers. Further, the method can also comprise receiving a requested item identifier and a customer address from one of said members, wherein said requested item identifier matches one of said item identifiers wherein said requested item identifier identifies a requested item said customer offers to purchase from said merchant, identifying each of said affiliated partner profiles that comprises said requested item identifier, determining distances between said customer address and said merchant address inside each of said affiliated partner profiles comprising said requested identifiers, and choosing one or more of said item listings based on said distances.

Lastly, in one embodiment, the system that networks independent sellers of items can comprise a computer readable storage medium having a computer readable program code embodied therein. The said computer readable program code can be adapted to be executed to implement the above mentioned gunfire detection method.

### BRIEF DESCRIPTION OF THE DRAWINGS

FIG. 1 illustrates a vast region showing merchants in multiple locations.

FIG. 2 illustrates a merchant linking system comprising a plurality of merchant computers, one or more merchant servers, and a merchant-linking server connected by a network.

FIG. 3a illustrates a merchant server.

FIG. 3b illustrates a merchant-linking server.

FIG. 4a illustrates a merchant server memory.

FIG. 4b illustrates a merchant-linking server memory.

FIG. 5 illustrates a customer profile.

FIG. 6 illustrates an affiliated partner profile.

FIG. 7 illustrates an inventory catalog.

FIG. 8 illustrates a merchant access website.

FIG. 9 illustrates a merchant website.

FIG. 10 illustrates a payment flowchart for one embodiment of the disclosure.

FIG. 11 illustrates a payment flowchart for a second embodiment of the disclosure.

FIG. 12 illustrates a payment flowchart for a third embodiment of the disclosure.

### DETAILED DESCRIPTION

Described herein is a system and method for networking independent sellers of items. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

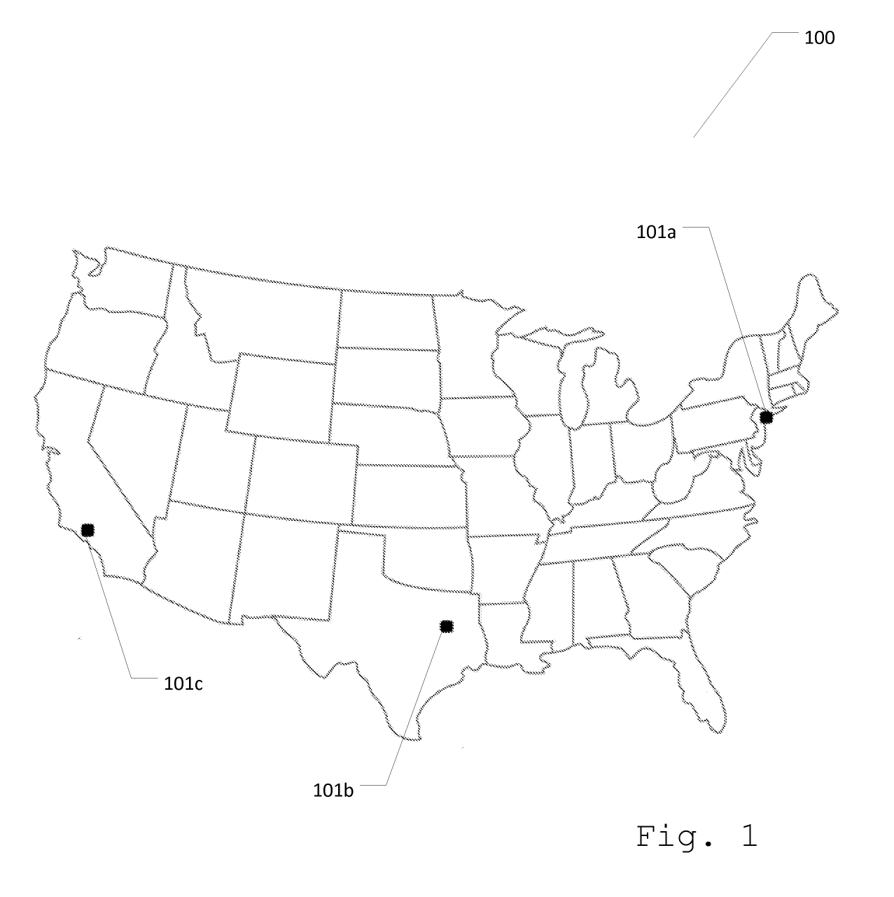

FIG. 1 illustrates a vast region 100 showing merchants 101 in multiple locations. In the example given in FIG. 1, merchant 101a resides in New York City, merchant 101b resides in Dallas, and merchant 101c resides in Los Angeles. In practice, there can be many merchants, across region 100, some in the same local area as other merchants. Each merchant 101 can be an Affiliated Partner, member, or both, as discussed below.

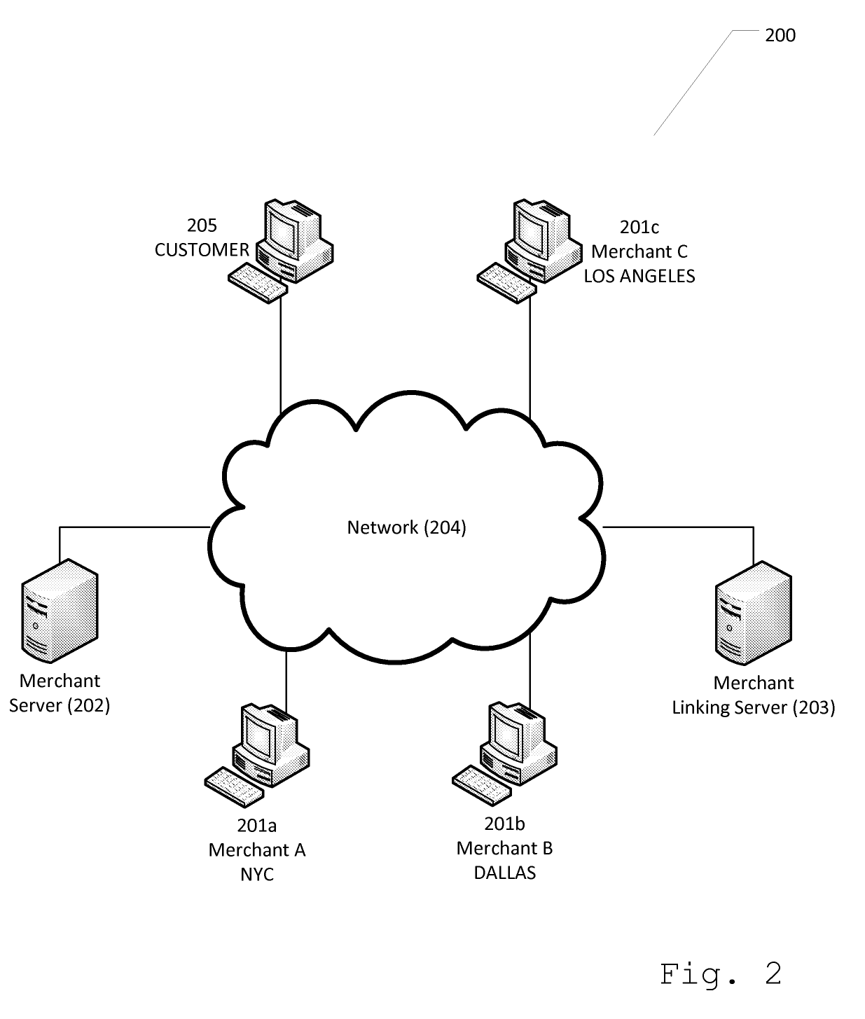

FIG. 2 illustrates a merchant linking system 200 comprising a plurality of merchant computers 201, one or more merchant servers 202, and a merchant-linking server 203 connected by a network 204. Merchant-linking system 200 can communicate with a customer computer 205 via network 204. Each merchant computer 201 can be associated with a unique merchant 101. Each merchant computer 201 and customer computer 205 can include, but is not limited to, a laptop, desktop, server, workstation, or portable device. Merchant linking system 200 may also comprise a merchant server 202 and a merchant-linking server 203. Merchant server 202 can be physically located or be remote from merchant. Further, merchant server 202 can belong to a remote merchant or to a third party server provider. In one embodiment, merchant server 202 and merchant-linking server 203 can be the same server. Network 204 can be a wide area network (WAN), or a combination of local area networks (LANs), WANs and/or piconets. Network 204 can be hard-wired, wireless, or a combination of both. One illustrative LAN is a network within a single business. One illustrative WAN is the Internet.

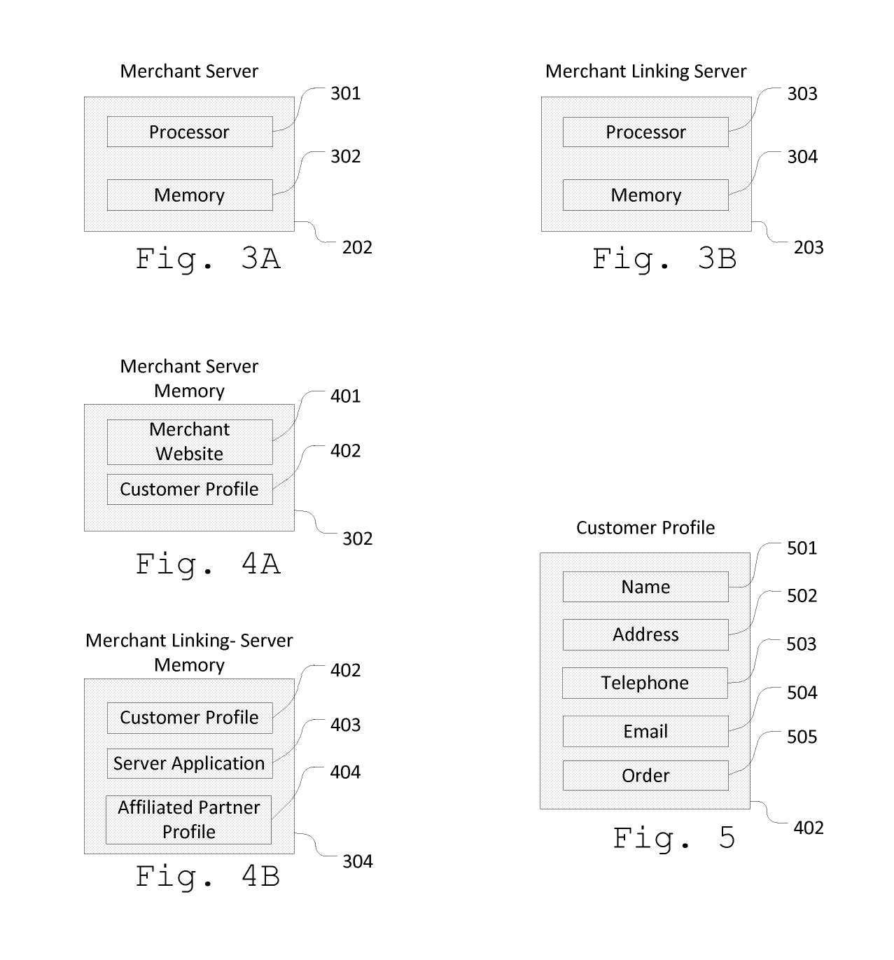

FIG. 3 illustrates the internal hardware of merchant server 202 and merchant-linking server 203. FIG. 3a illustrates merchant server 202. Merchant server 202 can comprise a merchant server processor 301, and a merchant server memory 302. Merchant server processor 301 can perform a set of instructions stored within merchant server memory 302. Merchant server memory 302 can reside with the same structure as merchant server processor 301, as is the case in a typical desktop or laptop computer. Merchant server memory 302 can be combinations of server-based memory, direct connect memory, network based memory, or in any other configuration known in the art.

FIG. 3b illustrates merchant-linking server 203. Merchant-linking server 203 can comprise a merchant-linking server processor 303, and a merchant-linking server memory 304. Merchant-linking server processor 303 can perform a set of instructions stored within merchant-linking server memory 304. Merchant-linking server memory 304 can reside with the same structure as a merchant-linking server processor 303. Merchant server memory 304 can be combinations of server-based memory, direct connect memory, network based memory, or in any other configuration known in the art.

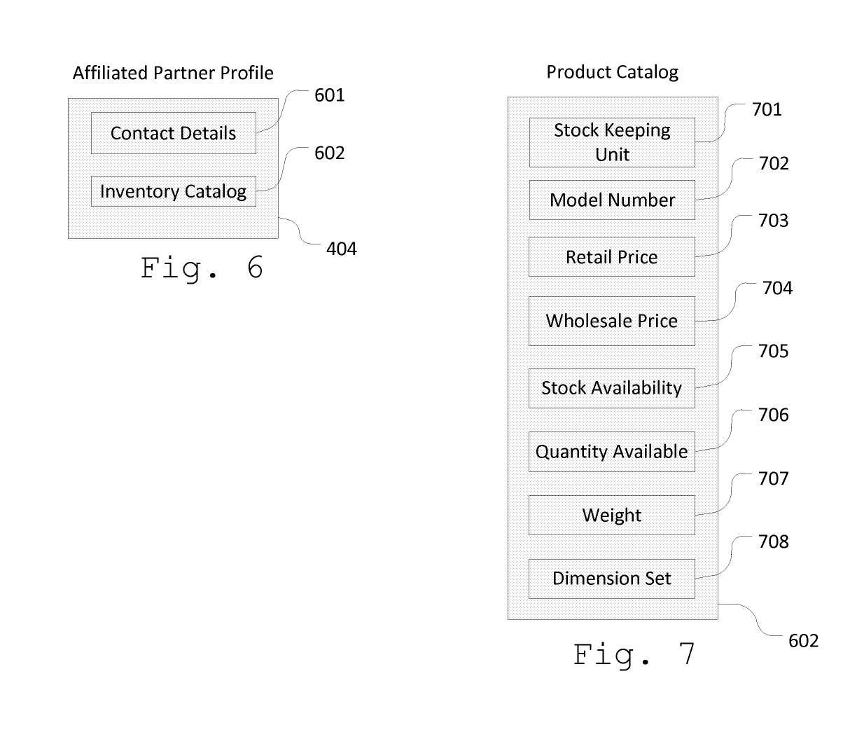

FIG. 4 illustrates server memory. FIG. 4a illustrates merchant server memory 302. Merchant memory 302 can comprise a merchant website 401. For purposes of this disclosure, merchant website 401 can be a solely HTML site, or can comprise HTML and on or more applications used to transmit and receive information to and from customers and/or send information to server application. In one embodiment, merchant memory 302 can also comprise a one or more customer profiles 402 that can be created, edited and deleted by the customer through merchant website 401.

FIG. 4b illustrates merchant-linking server memory 304. Merchant-linking server memory 304 can comprise a server application 403, one or more customer profiles 402, and/or a one or more affiliated partner profiles 404. Server application 403 can reside and execute within merchant-linking server memory 304, and can receive and transmit instructions and data across network 204. In an embodiment wherein merchant website 401 and server application 403 reside on the same server, i.e., merchant server 202 and merchant-linking server 203 are the same server, server application 403 can be programmed to transmit and receive information with merchant website 401 within the server.

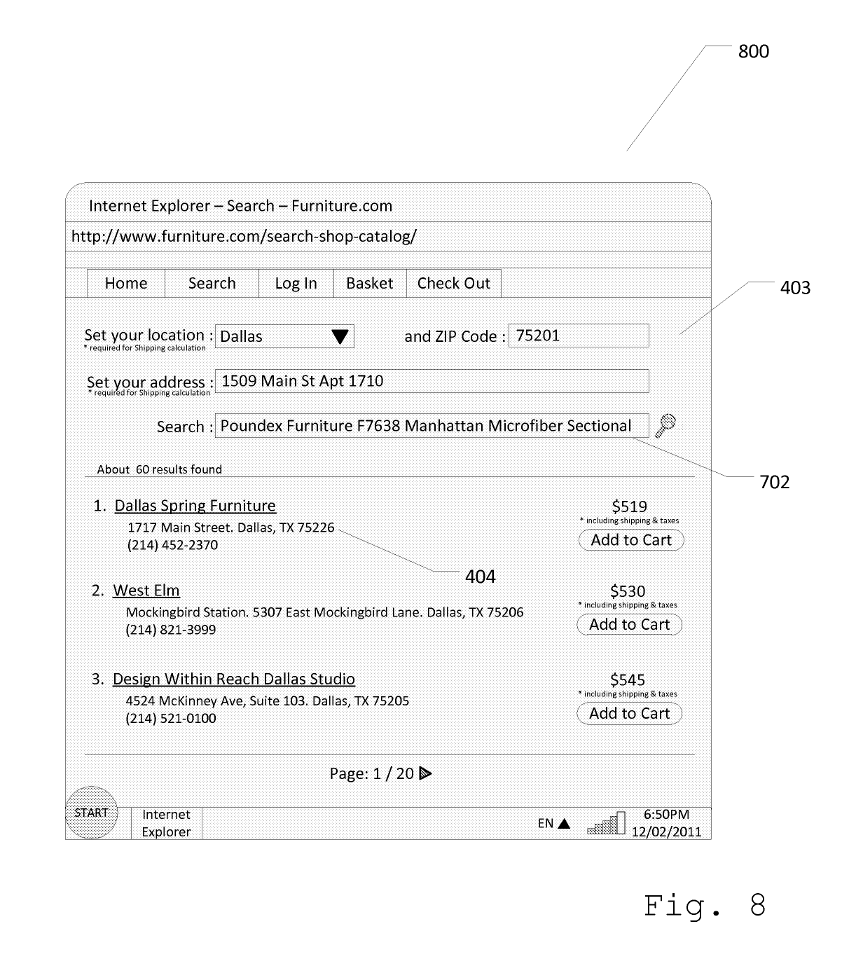

FIG. 5 illustrates a customer profile 402. Customer profile 402 can comprise a name 501, an address 502, a telephone number 503, an email 504 and/or an order record 505. Name 501 can include a first name, a middle name, and/or last name. Address 502 can include but is not limited to, a work address, a residential address, or a residential address of a customer. In one embodiment wherein address 502 is a residential address, a furniture item, invoice, warranty card, and/or receipt can be delivered to a customer via postal mail. Email 504 can be used by server application 403 to send messages to a customer or to a group of customers. Order record 505 can be a record of past and/or present orders associated with a customer.

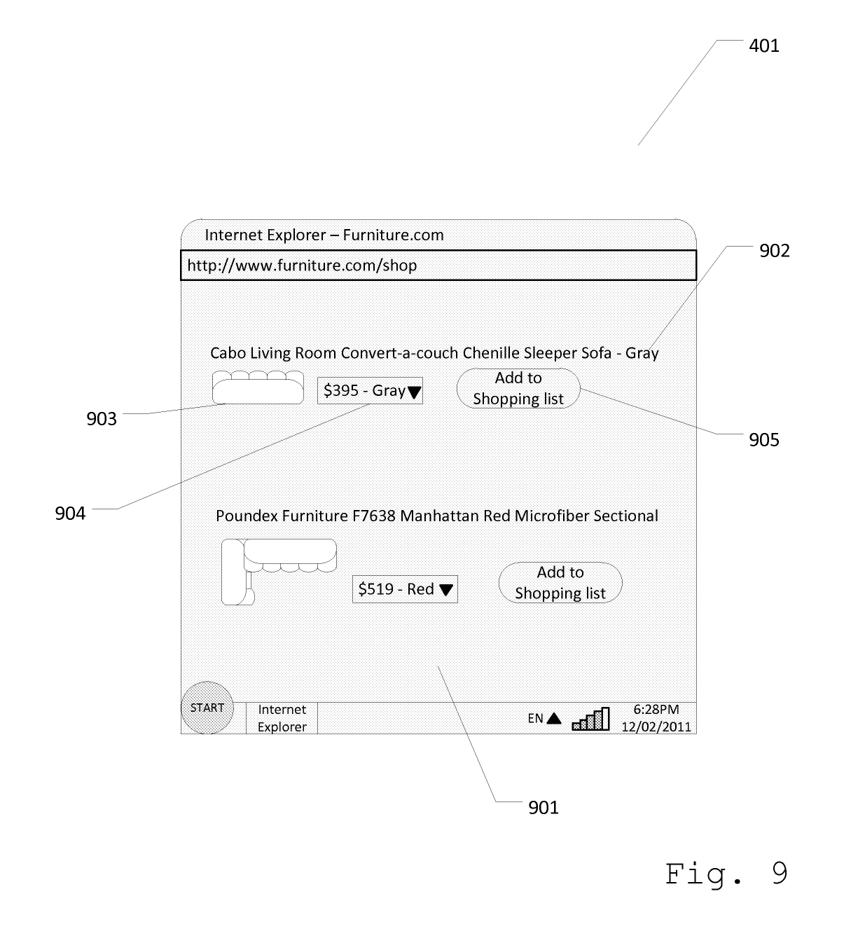

FIG. 6 illustrates an affiliated partner profile 404. Affiliated partner profile 404 can comprise a one or more contact details 601, and/or a one or more inventory catalog 602. Contact details can include a merchant name, a merchant address, a merchant telephone number, a merchant website, and a merchant location. Affiliated partner profile 404 can show up during a search by a remote merchant for another merchant that is local to a customer, as discussed further below.

FIG. 7 illustrates inventory catalog 602. Inventory catalog 602 can comprise information related to individual 8 tejs, including a stock keeping unit 701, an item identifier 702, a retail price 703, a merchant network price 704, a stock availability 705, a quantity available 706, weight 707, and/or a dimension set 708. Stock keeping unit 701 can be a number or a code for identifying each unique furniture item available in the merchant's inventory catalog 602. Item identifier 702 can be such as a 8 tej name, a model number or any other combination of numbers and string to identify an item model. Item identifier 702 is typically supplied by the manufacturer of the item An item can have a retail price 703 and a wholesale price 704 for customers. Stock availability 705 can be string characters “YES” and “NO” representing if a merchant have any stock available or not. Quantity available 706 can represent the number of items available in the merchant's inventory. Weight 707 can also be used to calculate shipping/delivery fees from the local merchant's warehouse to an end customer after a purchase. Dimension set 708 can represent the width, height, and/or depth of a furniture item.

Inventory catalog 602 will be in affiliated partner profile 404 for each merchant 101 that is an Affiliated Partner. An Affiliated Partner is any merchant 101 whose affiliated partner profile 404 comprises an inventory catalog 602 on or available through merchant-linking server 203. Affiliated partner profile 404 is accessible over network 204, but is not publicly available. Instead, affiliated partner profile 404 is only available to merchants 101 who are Members of the merchant-linking system. Stated another way. A Member is a merchant 101 who has authority to query all or a portion of affiliated partner profiles 404 for the purpose of finding 8 tejs available for sale in a particular geographic location. In one embodiment, a Member may be restricted by server application 403 to selling a particular brand of goods. In another embodiment, a Member may be restricted by server application 403 to selling items only in a particular location. In another embodiment, an Affiliated Partner may be restricted by server application 403 to selling a particular set of items. In another embodiment, an Affiliated Partner may be restricted by server application 403 to selling goods only in a particular location.

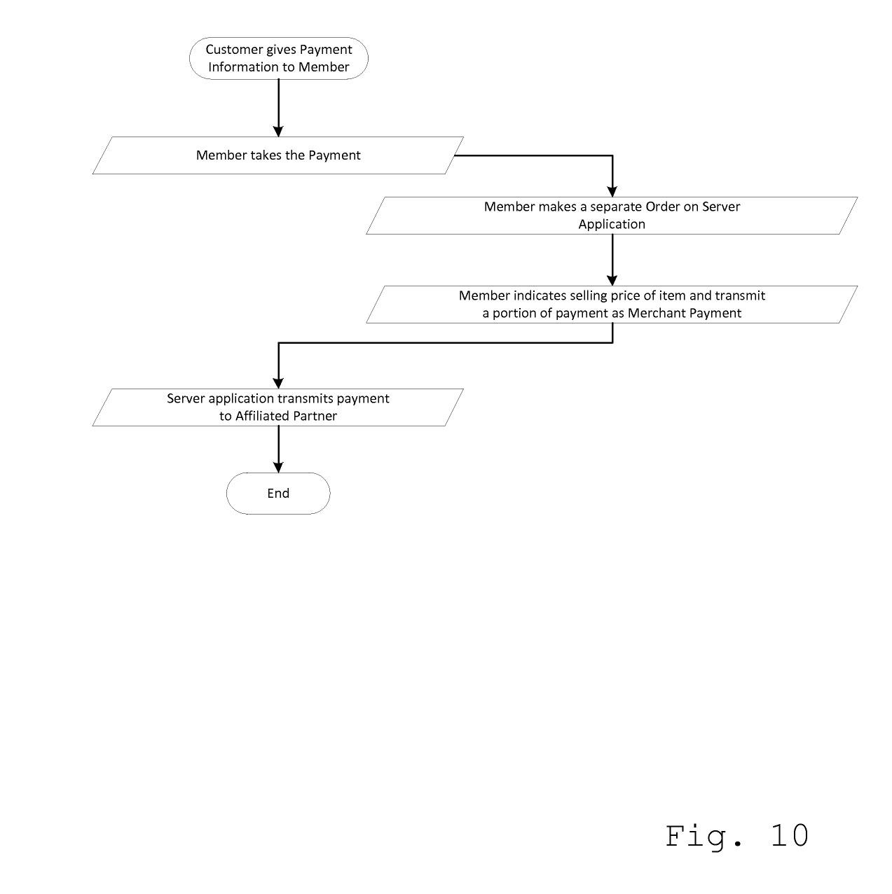

FIG. 8 illustrates a merchant access website 800. In one common furniture-buying scenario, a customer contacts a remote merchant, inquiring about an advertised item. In response, the remote merchant can check available inventory, and give a quote to the customer. In one embodiment of the disclosed invention, Members can advertise items. A customer interested in buying the item can notify the Member of his or her interest in the item. Then, the Member can, using computer 201, sign into his account in server application 403. Once in the account, the Member can query a database comprising affiliated partner profiles 404. In the query field, the Member can input a delivery address associated with customer, along with an item identifier 702. Server application 403 can find Affiliated Partners that have inventory with the item identifier. Server application 403 can also compare merchant addresses to the customer's deliver address, using systems and methods known in the art, to calculate a merchant distance for each merchant. Then server application 403 can determine the merchant or merchants closest to customer by comparing merchant distances. In one embodiment, server application 403 can further compare the merchant distance for each merchant to maximum deliver distance to determine whether it is within the maximum delivery distance parameter. Using systems and methods commonly known in the art, server application 403 to find local merchants close to customer having the item that customer wishes to buy.

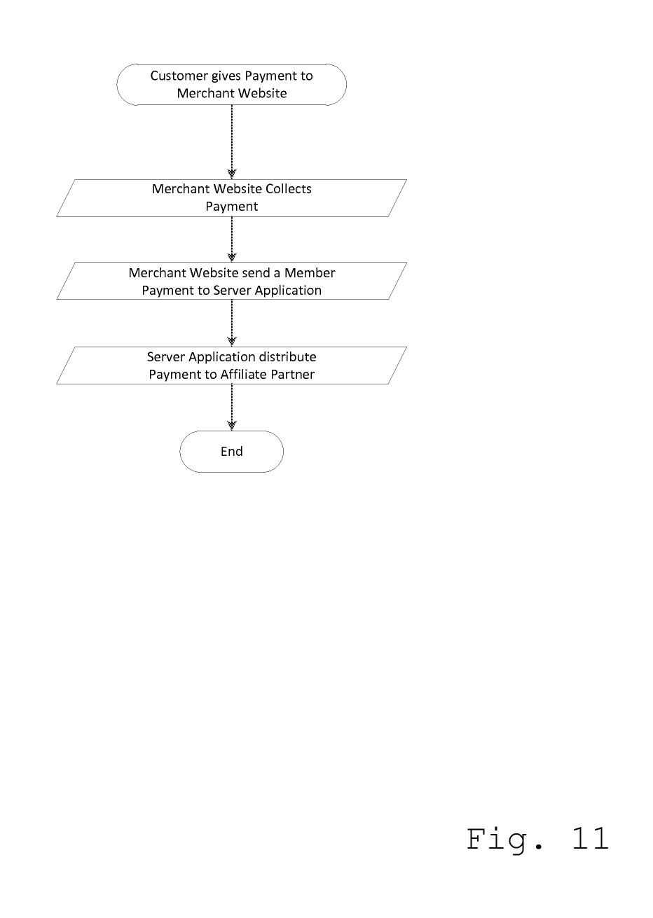

FIG. 9 illustrates merchant website 401. In another common furniture buying scenario, a customer visits merchant website 401. There the customer is able to shop, choose items he or she likes, and make purchases that will be delivered to them. In another embodiment of the disclosed invention, merchant website 401 can exist on merchant server 202. In such configuration, merchant website 401 one or more items offered for sale within a cart 901. Cart 901 is software for selling items over the Internet, hosted and running on merchant server 202 or a host (third party) server. Cart 901 can comprise one or more descriptive texts 902 that provide a title to the selling item, and/or provide a description of the selling item. Cart 901 can further comprise one or more pictures 903 placed near descriptive text 902, as shown in FIG. 8. Additionally, cart 901 can comprise input fields 904 such as text fields, check boxes, radio buttons, and/or dropdown menus to present the customer with options available such as colors, sizes, or quantities of items. Furthermore, cart 901 can includes system buttons 905 for navigation. System buttons 905 offer the user the possibility to interact with cart 901 by providing instructions. Examples of providing instructions are, but not limited to, add the relevant items to the cart basket, remove an item from the cart basket, and/or check out to finalize the purchase.

In one embodiment, merchant website 401 can auto-populate itself by signing into Merchant account in server application 403 and querying a database comprising all or a portion of affiliated partner profiles 404. In another embodiment, the items for sale on merchant website 401 can be populated by the Member who owns merchant website 401. In another embodiment, server application 403 can populate merchant website 401 according to a set of items the Member is allowed to sell using merchant linking system 200. Then server application 403 can send the list of items to merchant website 401. In one embodiment server application 403 can also send item identifier 702 for each type of item on the list. A unique identifier can be an alphanumeric string, or any combination of information from merchant profile that uniquely identifies an item in stock with a particular affiliated partner. In any of these embodiments, a Member can establish further parameters to further limit which item he or she will sell. When a customer makes an offer to buy an item, merchant website 401 can transfer to server application 403 the offer. The offer can include the unique identifier of the item, the customer's name, the customer's address, the customer's phone number, the price of the item, and/or payment information.

After receiving the offer, server application 403 can query affiliated partner profiles 404 using the unique identifier of the item. Server application 403 can find Affiliated Partners that have the item available for sale. Server application 403 can also compare merchant addresses to the customer's deliver address, using systems and methods known in the art, to calculate a merchant distance for each merchant. Then server application 403 can determine the Affiliated Partner closest to customer by comparing merchant distances. In one embodiment, server application 403 can further compare the merchant distance for each merchant to maximum deliver distance to determine whether it is within the maximum delivery distance parameter. Using systems and methods commonly known in the art, server application 403 to find local merchants close to customer having the item that customer wishes to buy. In one embodiment, server application 403 can calculate a delivery charge based on the location of the Affiliated Partner or the customer, the distance between the Affiliated Partner and the customer, and/or the item being delivered. Such shipping price can then be communicated to merchant website 401, wherein merchant website 401 can complete the transaction with the customer. In another embodiment, all information relevant for calculating shipping cost can be transferred from server application 403 to merchant website 401, wherein merchant website can calculate a delivery cost and complete the transaction with the customer. In another embodiment, shipping costs can be a flat rate. In such embodiment, calculation is unnecessary.

FIG. 10 illustrates a payment flowchart for one embodiment of the disclosure. In one embodiment, customer can give payment information such as a credit card or bank account and routing number directly to Member. Member then can collect payment. In such embodiment, Member can make a separate order on behalf of customer on server application 403, as described above. In such embodiment, merchant can tell server application 403 how much he sold the item for, and send a portion of that amount as a merchant payment. This amount can be communicated to customer when the order is shipped to prevent merchant from putting an incorrect value.

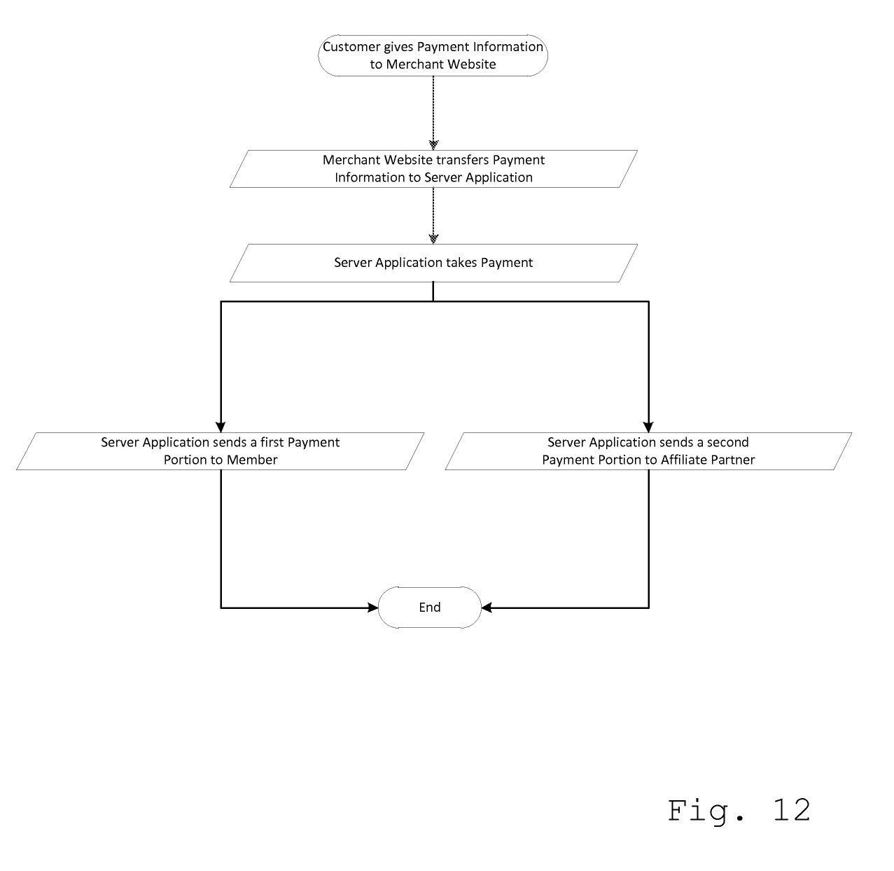

FIG. 11 illustrates a payment flowchart for a second embodiment of the disclosure. In another embodiment, customer can give payment to merchant website 401. Merchant website 401 can then collect payment. After collecting payment, merchant website 401 can send a Member payment to server application 403. Server application can 403 can then distribute a payment to affiliated partner.

FIG. 12 illustrates a payment flowchart for a third embodiment of the disclosure. In another embodiment, customer can give payment information to merchant website 401. Merchant website 401 can then transfer payment information to server application 403. Server application 403 can then take the payment. After taking payment, server application 403 can then cause a first payment to be distributed to Member and a second payment to be distributed to Affiliated Partner.

Payments can be calculated in a number of ways. In one embodiment, Affiliated Partners can establish a price, and pay a commission to merchant linking system 200 for each item sold over merchant-linking system 200. Such commission can be split by merchant-linking system 200 with Member. In another embodiment, two prices can be set by merchant-linking system 200 on server application: a selling price to Member, and a buying price from Affiliated Partner. In another embodiment, price can be set by Member and communicated to server application 403. A commission can be charged by server application 403 and split with Affiliated partner. In any embodiment involving a commission, commission can be charged based on the total amount of a sales transaction or can be charged based on net proceeds.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A method for networking independent sellers of items comprising the steps
storing in a memory a plurality of affiliated partner profiles each associated with an affiliated partner, said affiliated partner profiles comprising a merchant address and an inventory catalog comprising a plurality of item listings, each identifiable by an item identifier; and
storing in said memory a member profile associated with a member, said member profile comprising an item list, said item list comprising one or more of said item identifiers.

2. The method of claim 1 further comprising the steps
receiving a requested item identifier and a customer address from one of said members, wherein said requested item identifier matches one of said item identifiers wherein said requested item identifier identifies a requested item said customer offers to purchase from said merchant;
identifying each of said affiliated partner profiles that comprises said requested item identifier;
determining distances between said customer address and said merchant address inside each of said affiliated partner profiles comprising said requested identifiers; and
choosing one or more of said item listings based on said distances.

3. The method of claim 2, prior to receiving said requested item identifier, further comprising the step
transmitting one or more said item list to said associated member, said item identifiers on said item list identifying items said member can offer for sale to a customer.

4. The method of claim 2, after receiving said requested identifier, further comprising the step verifying said requested item identifier is one of said item identifiers in said item list.

5. The method of claim 2, further comprising the step transmitting said chosen item listings to said member.

6. The method of claim 2 wherein said requested item identifier received from said member is generated from a website belonging to said member.

7. The method of claim 6 wherein transmitting said chosen item listings to said member comprises transmitting said item listings to said member website.

8. The method of claim 1 wherein choosing one or more of said item listings comprises choosing said item listing comprising said shortest distance between said customer address and said merchant address.

9. The method of claim 1 wherein choosing one or more of said item listings comprises choosing each item listing associated with said merchant address within a predetermined distance from said customer address.

10. The method of claim 1 wherein one or more of said item listings is a furniture listing.

11. A system that networks independent sellers of items, comprising
a merchant-linking server memory that stores
a plurality of affiliated partner profiles each associated with an affiliated partner, said affiliated partner profiles comprising a merchant address and an inventory catalog comprising a plurality of item listings, each identifiable by an item identifier; and
a member profile associated with a member, said member profile comprising an item list, said item list comprising one or more of said item identifiers; and
a server application
a merchant-linking server processor that, according to instructions from said server application,
receives a requested item identifier and a customer address from one of said members, wherein said requested item identifier matches one of said item identifiers wherein said requested item identifier identifies a requested item said customer offers to purchase from said merchant;
identifies each of said affiliated partner profiles that comprises said requested item identifier;
determines distances between said customer address and said merchant address inside each of said affiliated partner profiles comprising said requested identifiers; and
chooses one or more of said item listings based on said distances.

12. The system of claim 11 wherein said requested item identifier from said member originates from a merchant-server processor at the direction of a merchant application stored in a merchant server memory.

13. The system of claim 12 wherein said requested item identifier travels from said merchant-server processor to said merchant-linking server processor over a network.

14. The system of claim 12 wherein said merchant-server processor is said merchant-linking processor.

15. The system of claim 12 wherein said merchant-linking server memory is said merchant server memory.

16. The system of claim 12 wherein said merchant-linking server processor also transmits to said merchant application said item list, further wherein said requested item identifier is one of said one or more identifiers in said item list.

17. The system of claim 12 wherein said merchant linking server processor also verifies that said requested item identifier is one of said item identifiers in said item list associated with said member profile of said member.

18. The system of claim 11 wherein said processor further receives a purchase order for an item related to said requested item identifier from said member as a result of a customer agreeing to purchase said item.

19. The system of claim 19 wherein said processor further transmits to said affiliated partner a delivery order, wherein said delivery order comprising said customer address and said requested item identifier.

20. A computer readable storage medium having a computer readable program code embodied therein, wherein the computer readable program code is adapted to be executed to implement the method of claim 1.
